(19) United States
(12) Patent Application Publication
(10) Pub. No.: US 2011/0131536 A1
(43) Pub. Date: Jun. 2, 2011

(54) GENERATING AND RANKING INFORMATION UNITS INCLUDING DOCUMENTS ASSOCIATED WITH DOCUMENT ENVIRONMENTS

(75) Inventors: Wei Peng, Webster, NY (US); Tong Sun, Penfield, NY (US)

(73) Assignee: Xerox Corporation, Norwalk, CT (US)

(21) Appl. No.: 12/629,401

(22) Filed: Dec. 2, 2009

(51) Int. Cl. G06F 17/30; G06F 3/048; G06F 3/01

(52) U.S. Cl. 715/848; 707/748; 707/769; 715/753; 707/E17.014; 707/E17.017

(57) ABSTRACT

Embodiments described herein are directed to forming information units. Digital documents associated with collaborative navigation behavior information can be identified and an information unit can be generated using transition probabilities calculated from collaborative navigation information. The information unit including at least a subset of the digital documents identified in the collaborative navigation behavior information. A rank of information unit based on the collaborative navigation behavior information can be calculated.

### BACKGROUND

1. Technical Field

The presently disclosed embodiments are directed to processing documents using collaborative navigation behavior information to generate and/or rank information units comprising documents associated with one or more document environments.

2. Brief Discussion of Related Art

Most search engines, such as Google, Yahoo, Microsoft Live, retrieve and rank web pages using a hyperlink graph, where the web pages are nodes and the edges or links between the nodes represent explicit hyperlinks between the web pages. The ranking algorithms employed typically simulate a web browser taking a random walk on this link graph using a discrete-time Markov Process. These conventional types of page-rank algorithms are widely used. The hyperlink graphs used by these ranking algorithms tend to be unreliable because hyperlinks can be added and deleted from web pages by web content creators. Furthermore, hyperlink graph-based ranking typically algorithms ignore digital documents that do not include hyperlinks. In addition, users accessing individual web pages returned in search engine results may not understand the context of the web page because the authors of the web page usually assume that the readers come through a path to that page and already know the context.

### SUMMARY

According to aspects illustrated herein, there is provided a method for processing documents associated with one or more document environments to processing documents associated with one or more document environments to form an information unit. The method includes identifying digital documents associated with collaborative navigation behavior information for a group of users and generating an information unit using transition probabilities calculated from collaborative navigation information. The information unit includes at least a subset of the digital documents identified in the collaborative navigation behavior information. The method further includes calculating a rank of information units based on the collaborative navigation behavior information of a group of users.

According to other aspects illustrated herein, there is provided a computer readable medium storing instructions executable by a computing system including at least one computing device, wherein execution of the instructions implements a method for processing documents associated with one or more document environments to form an information unit. The method implemented when the instructions are executed includes identifying digital documents associated with collaborative navigation behavior information for a group of users and generating an information unit using transition probabilities calculated from collaborative navigation information. The information unit including at least a subset of the digital documents identified in the collaborative navigation behavior information. The method implemented when the instructions are executed includes calculating a rank of information units based on the collaborative navigation behavior information of a group of users.

According to further aspects illustrated herein, there is provided a system for processing documents associated with one or more document environments to form an information unit. The computing system includes at least one computing device. The computing system is configured to identify digital documents associated with collaborative navigation behavior information for a group of users and generate an information unit using transition probabilities calculated from collaborative navigation information. The information unit includes at least a subset of the digital documents identified in the collaborative navigation behavior information. The computing system is further configured to calculate a rank of information units based on the collaborative navigation behavior information of a group of users.

### BRIEF DESCRIPTION OF THE DRAWINGS

FIG. 1 is a block diagram illustrating an exemplary computing system in which a navigation assistance tool can be implemented.

FIG. 2 illustrates exemplary collaboration navigation behavior information and matrices that can be formed from the set of digital documents using the collaborative navigation behavior information.

FIG. 3 is an exemplary information unit graph that can be generated by exemplary embodiments of a navigation assistance tool.

FIG. 4 is an exemplary combined navigation behavior graph that can be generated by exemplary embodiments of a navigation assistance tool.

FIG. 5 are exemplary 3D areas for displaying digital documents associated with information units of a combined navigation behavior graph.

FIG. 6 is a block diagram of an exemplary computing device configured to implement embodiments of a navigation assistance tool.

FIG. 7 is a flowchart illustrating an exemplary process for generating an information unit.

FIG. 8 is a flowchart illustrating an exemplary process for generating a combined navigation behavior graph.

### DETAILED DESCRIPTION

Exemplary embodiments are directed to generating information units and/or generating a combined navigation behavior graph based on collaborative navigation behavior information. The collaborative navigation behavior information can be composed of recorded navigation behavior information associated with a group of users. Digital documents associated with the collaborative navigation behavior can be identified using embodiments of a navigation assistance tool and a rank score can be calculated for the digital documents. Information units can be generated based on the digital documents identified in the collaborative navigation behavior information using transition probabilities calculated, for example, by the navigation assistance tool. A combined navigation behavior graph can be generated with the information units and rank identifiers can be used to identify a rank of the information units. The combined navigation behavior graph can provide one or more learning paths for users to learn and/or review subject matter associated with the information units.

As used herein, a “digital document” refers to computer file that contains information. Some examples of digital documents include word processing files, portable digital document files (PDFs), spreadsheet files, slide presentation files, image files, video files, sound files, 3D model files, virtual world files, web pages, extensible mark-up language (XML) files, and the like.

As used herein, “processing documents” refers to performing operations based on, for example, navigation behavior associated with the digital documents and a “document environment” refers to an environment in which documents can be organized, presented, stored, and the like. Some examples of a document environment can include a 3D virtual world, a document management system, a website, and the like.

As used herein, “transition probability” refers to a probability of transitioning from one digital document to another digital document. The probability can be calculated using actual transition information in navigation behavior information and/or collaborative navigation behavior information.

As used herein, an “amount” refers to a quantity or size and can be represented as a number, ratio, percentage, and the like.

As used herein, “calculating” refers to determining, ascertaining, and/or performing computations using mathematical methods.

As used herein, a “keyword query” refers to using one or more words as input terms to perform a search against a repository or database.

As used herein, a “starting point” refers to an initial or beginning of something, such as a digital document selected as a starting point for generating an information unit.

As used herein, “comparing” refers to examining, determining, calculating, ascertaining, and/or identifying similarities and/or differences between two or more objects or things, such as between two or more values. For example, a transition probability can be compared to a transition probability threshold value.

As used herein, “transitioning” refers to going from an object or thing to another object or thing. For example, going from one digital document to another digital document.

As used herein, a “transition probability threshold value” refers to a quantity that is specified for comparison to a transition probability.

As used herein, “connecting” refers to joining and/or associating one object or thing with another object or thing. For example, documents can be joined or associated to form an information unit and/or an information unit graph.

As used herein, “indexing” refers to a schema for facilitating identification and/or retrieval of objects or things from a repository and/or database. For example, indexing can be used to identify and retrieve information units from a repository in response to a keyword query.

As used herein, a “virtual world” refers to a computer simulated environment in which users, represented as avatars, can interact, and a “three-dimensional virtual world” or “3D virtual world” refers to a virtual world defined in a 3D space.

As used herein, an “avatar” refers to a computer animation of a user in a virtual world.

As used herein, a “3D area” refers to a defined space and/or location in a virtual world, such as, for example, a virtual room.

As used herein, “transferring” refers to moving, copying, or mapping an object or item, such as moving, copying, or mapping digital documents to a 3D area.

As used herein, a “client device” or “client” refers to a computing device typically used by a user in a network environment to interact with a server device, where a “server device” or “server” refers to a computing device that typically serves digital documents or server-side computing applications to clients.

As used herein, a “repository device” or “database device” refers to a storage device for storing digital documents.

As used herein, “ranking” refers to sorting, sequencing, or otherwise assigning a rank to an object or thing to facilitate an ordering objects or things. For example, assigning a rank to information units based on collaborative navigation behavior information, where “rank” refers to a value based standing of an object relative to other objects or thing based on, for example, a rank score. As used herein, a “rank score” refers to a value calculated for an object or thing, such as a digital document and/or an information unit, used for ranking the object or thing relative to other objects or things. For example, a digital document having high rank score has a higher rank than a digital document having a lower rank score.

As used herein, a “learning path” refers to a navigation path or paths that a user can take when reviewing, organizing and/or learning about subject matter contained in digital documents. For example, if a user searches for ‘Java tutorial’, the learning path can be a navigation path from a beginner level or introductory digital documents to advanced level of material.

As used herein, “navigation behavior information” refers to characteristics, trends, traits, and the like, which can be determined based on interactions with digital documents by users. Some examples of navigation behavior information include digital documents visited, viewed, or otherwise accessed by a user, a time spent on a digital document, transitions between digital documents, and the like. Time spent on a digital document can refer to an amount of time that a user has a digital document open, has viewed a document, and/or has otherwise accessed the digital document.

As used herein, a “collaborative navigation behavior information” refers to an aggregation, accumulation, combination, and the like, of navigation behavior information for one or more users. For example, navigation behavior information for a group of users can be combined together to form collaborative navigation behavior information.

As used herein, an “information unit” refers to a group or collection of digital documents that are identified as being associated based on navigation behavior information of users, which can be determined independent of an explicit link between the digital documents.

As used herein, an “information unit graph” refers to a graphical representation of an information unit. Information unit graphs can be implemented as, for example, a directed graph having nodes and edges, where nodes represent digital documents and edges refer to lines connecting nodes. Information unit graphs can use one or more graphic models, such as a spring layout model, a circular model, a hierarchical model, and the like.

As used herein, a “continuous time-homogeneous Markov Process” refers to a well known random or stochastic process in which future values of a random variable are statistically determined by present events and are typically dependent only on the event immediately preceding.

A “Markov chain” refers to a Markov process that is restricted to discrete random events or to discontinuous time sequences.

As used herein, “recording” refers to capturing and/or collecting information and storing the information in computer storage. Information recorded can be stored in one or more computer formats.

As used herein, a “combined navigation behavior information graph” refers to a graph combining navigation paths of a group of users. The combined navigation behavior graph includes information units as sub-graphs.

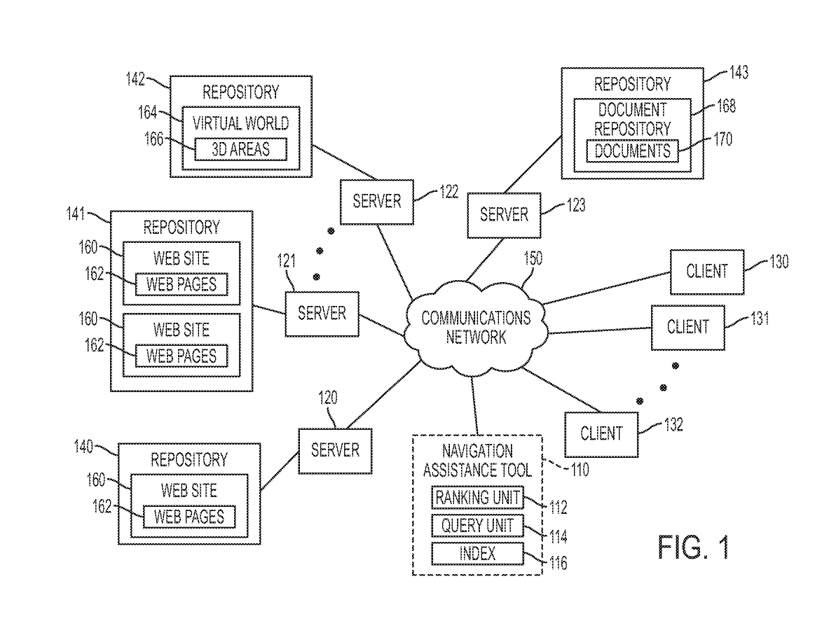

FIG. 1 is an exemplary computing system 100 in which a navigation assistance tool 110 (hereinafter “tool 110”) can be implemented. The computing system 100 includes one or more server devices 120-123 (hereinafter “servers 120-123”) coupled to client devices 130-132 (hereinafter “clients 130-132”), via a communication network 150, which can be any network over which information can be transmitted between devices communicatively coupled to the network. For example, the communication network 150 can be the Internet, intranet, Virtual Private Network (VPN), Local Area Network (LAN), Wide Area Network (WAN), and the like. The computing system 100 can include repositories or database devices 140-143 (hereinafter “repository devices 140-143”), which can be communicatively coupled to the servers 120-123. The servers 120-123 and repository devices 140-143 can be implemented using computing devices. In some embodiments, the repository devices 140-143 can be integrated with the servers 120-123. In some embodiments, the repository devices 140-143 can be separate from the servers 120-123.

The servers 120-123 can be configured to provide various digital documents stored in the repository devices 140-143 to the client devices 130-132 via one or more interfaces implemented by the servers 120-123. For example, the servers 120 and 121 can be configured as web servers to access repository devices 140-141 to provide various websites 160 having web pages 162 to the clients 130-132, the server 122 can be configured to access repository devices 142 to provide the virtual world 164 having three-dimensional (3D) areas 166 in which digital documents can be displayed, and the server 123 can be configured to access repository devices 143 to provide a digital document management system having a digital document repository 168 storing computing digital documents 170. The servers 120-123 can interface with the repository devices 140-143 using software and/or hardware interfaces.

The clients 130-132 can be configured to be communicatively coupled to the servers 120-123 via a communication network 150. The clients 130-132 may indirectly communicate with the network 150 through, for example, a proxy server and/or may directly communicate with the network 150. The clients 130-132 can execute applications for interfacing with the servers 120-123 to send information to, and receive information from, the servers 120-123. For example, the clients 130-132 can be configured to implement a web browser for interfacing with one or more of the servers 120-122 to allow a user to retrieve and view web pages and/or interact with a virtual world. The clients 130-132 can be configured to implement a digital document management application to interact with a digital document management system provided by the server 123.

The tool 110 can include a ranking unit 112 and a query unit 114. The tool 110 can use recorded navigation behavior information associated with a group of users to generate one or more information units. The information units can be implemented as information unit graphs, which can provide a graphical representation of the information units. The information unit graphs can be implemented using one or more graphic models, such as a spring layout model, a circular model, a hierarchical model, and the like. The resulting information unit graphs can be used by the tool 110 to generate a combined navigation behavior graph. The information unit graphs can be sub graphs in the combined navigation behavior graph generated by the tool 110.

In some embodiments, the navigation behavior information can be recorded by a client-side application, such as a web browser and/or digital document management system implemented on the clients 130-132. The clients 130-132 can forward the recorded navigation behavior information to the tool 110, which can combine the recorded navigation behavior information to form collaborative navigation behavior information of the users of the clients 130-132. In some embodiments, the navigation behavior information can be recorded by the tool 110 and/or the servers 120-123. The tool 110 can use the collaborative navigation behavior information to rank digital documents included in the navigation behavior information, generate and rank information units, generate combined navigation behavior graphs.

The ranking unit 112 can identify digital documents, such as web pages, visited by users in browsing sessions using the collaborative navigation behavior information and can identify an amount of time the users spend on the digital documents. The rank score of the digital documents identified in the collaborative navigation behavior information can be calculated based on an amount of time users spend on each of the digital documents as well as transition probabilities for transitioning between the digital documents. The ranking unit 112 can use a continuous time-homogeneous Markov Process to simulate the collaborative navigation behavior information of the users based on the recorded navigation behavior information of the users and to calculate a rank score for digital documents identified by the ranking unit 112. The stationary probability distribution of the continuous time-homogeneous Markov Process can be computed using the transition probability matrix and a transition rate matrix (or Q-matrix), which represents a derivative of the transition probability matrix, can be used for ranking digital documents. The transition probability matrix can be a discrete embedded Markov chain with diagonal values of zero, and can be used to obtain a stationary probability vector using known techniques, such as the PageRank power method implemented by Google, Inc. Diagonal values of the Q-matrix can be estimated using training data, where the time spent on a document is an exponential distribution (P(Ti>t)=e^{q}^{ᵢᵢ}^{t}). A vector R can be generated such that each element of the vector R is a rank score for one of the digital documents. The elements of the vector R can be calculated as follows:

$${R}_{i} = \frac{\frac{{s}_{i}}{{q}_{ii}}}{{\sum }_{j = 1}^{n} \frac{{s}_{j}}{{q}_{jj}}} ,$$

where sᵢ is the stationary probability distribution calculated using the transition probability matrix for the i^{th} digital document, sⱼ is the stationary probability distribution calculated using the transition probability matrix for the j^{th} digital document, qᵢᵢ and qⱼⱼ are diagonal values of the Q-matrix, and n represents a total number of documents for which a rank score is to be calculated.

Information units can be generated by the ranking unit using, at least in part, transition probabilities calculated using the collaborative navigation behavior information. Rank scores of the information units can be calculated using, for example, a summation of the calculated rank scores of one or more of the digital documents in the information unit. When generating an information unit, the ranking unit 112 can select, as a starting point for generating the information unit, one or more of the digital documents identified in the collaborative navigation behavior information, such as a digital document having a high rank score relative to the remaining digital documents. The selected digital document can be associated with one or more of the remaining digital documents based on a transition probability for transitioning from the selected one or more digital documents to other digital documents.

For example, a first digital document can be associated with a second digital document when it is determined that the probability of transitioning from the first digital document to the second digital document is higher than a transition probability threshold (TPT) value. The transition probability threshold TPT can be a fixed, predetermined, configurable, and dynamic value. The probability of the transitioning from the first digital document to the second digital document can be calculated based on transitions that were recorded in the navigation behavior information of the users. While digital documents may be linked by hyperlinks, the transition probability can be calculated without regard to the hyperlinks. That is, the ranking unit 112 can calculate the transition probability based on actual transitions between digital documents recorded in the navigation behavior information without concern of how the transition is implemented.

The associations between digital documents, occurring when a transition probability is equal to, or greater than, the TPT value, can be represented in an information unit graph using an edge extending between nodes representing the digital documents. The transition probability can be unidirectional such that a transition probability for transitioning from a first digital document to a second digital document can be different than the transition probability for transitioning from the second digital document to the first digital document. The associations or connection between the digital documents can encode directional information. In this manner, a connection between digital documents can indicate a direction associated with the transition probability.

The ranking unit 112 continues to associate digital documents based on the probability of transitioning from one digital document to one or more other digital documents until, for example, there are no transition probabilities that are greater than, or equal to, the TPT value. The process of generating an information unit can be performed on one or more sets of digital documents to generate one or more information units. Using this approach, information units are generated that can be used by the ranking unit 112 when generating a combined navigation behavior graph. The composite navigation graph can be a combination of one or more of the information units represented as information unit graphs and can identify a ranking of the information unit graphs included in the combined navigation behavior graph relative to each other.

The ranking unit can include constructing rules to prune and/or maintain information units. Some transitions between digital documents can occur that should be ignored. The constructing rules can, for example, remove transition from the navigation behavior information that are not meant to be in the context path. As one example, users may back track while browsing documents before going forward down a different path such back track can be removed from the navigation behavior information. The constructing rules can, for example, remove transitions corresponding to selection of the back button in a web browser, back hyperlink in a web page, hyperlinks from a page to its parent page, and the like.

The query unit 114 can create an index 116 for the information units generated by the ranking to facilitate subsequent retrieval in response to a query or search request. In some embodiments, the index can associate keywords with the information units. The information units can be indexed and retrieved, in order, by measuring a relevance metric associated with the queried keywords against the rank score of information units generated by the ranking unit 112. In response to a query, the query unit 114 can interact with the ranking unit 112 to generate a combined navigation behavior graph incorporating information units returned by the query unit 114 in response to a query. A ranking of the information units relative to each other can be identified in the composite graph using one or more rank identifiers.

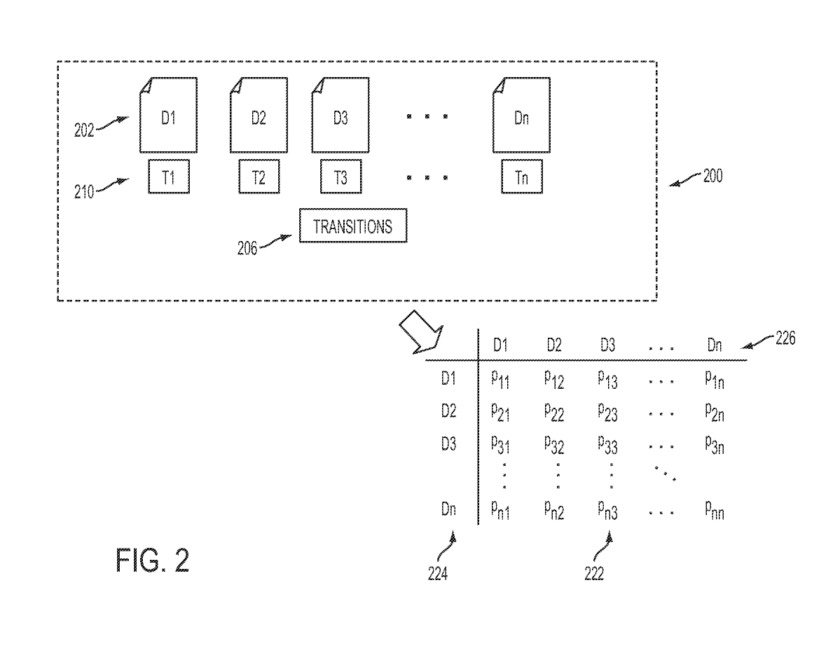

FIG. 2 shows collaborative navigation behavior information 200 including a set of digital documents 202, an amount of time users spent on the digital documents represented as time vectors 210, and transitions 206 that occurred between the digital documents 202. The set of digital documents 202 can include digital document D1 through digital document Dn, identified in collaborative navigation behavior information 200 associated with one or more users. The digital documents 202, amount of time spent on the digital documents 202, and transitions 206 can be used to generate time vectors 210 each of which includes time periods that users spent on a particular digital document and a transition probability matrix 220. For example, a time vector T1 can include time periods for which users remained on the document D1, a time vector T2 can include time periods for which users remained on the document D2, a time vector T3 can include time periods for which users remained on the document D3, and so on. A time vector for document i can be written as Tᵢ=(t₁, t₂, . . . , t₁). Each element t in one of the time vectors represents an amount of time a user spent on document i at some time. The length of a time vector depends on how many times users visited the corresponding document. Thus, the length of each of the time vectors can be different. This time information can be used in continuous time-homogeneous markov process when determining a ranking of the digital documents 202. Intuitively, the longer users remain on a specific digital document, as compared to other digital documents, the more important or relevant that digital document can be to the users.

Each entry 222 in the transition probability matrix 220 represents a probability that an arbitrary user will transition from a corresponding row digital document 224 to a corresponding column digital document 226, where the row digital documents 224 and the column digital documents 226 represent the digital documents 202. For example, p₁₂, in FIG. 2, represents the probability of transitioning from digital document D1 to digital document D2. In some embodiments, the probability can be calculated based on a number of times a transition occurred, as recorded in the navigation behavior information, from the digital document D1 to the digital document D2 compared to the number of times a transition occurred from digital document D1 to a digital document other than digital document D2. The transition probability matrix 220 can be used by the ranking unit of the tool when ranking the digital documents, forming connections between the digital documents and forming information units.

The set of digital documents 202 can be ranked using the collaborative navigation behavior information, including, for example, the time periods identified in the time vectors 210 and the transition probabilities 222 identified in the transition probability matrix. The vector R, having elements R1 through Rn that correspond to rank scores for digital documents 202, can be calculated using the stationary probability distribution of the continuous time-homogeneous Markov Process. For example, the elements R1 through Rn in the vector R can correspond to the digital documents D1 through Dn, respectively. The elements of the vector R can represent a ratio of time that users spend on a digital document compared to a total amount of time the user spends on all of the digital documents combined. Once the set of digital documents has been ranked, the ranking unit can generate one or more information units.

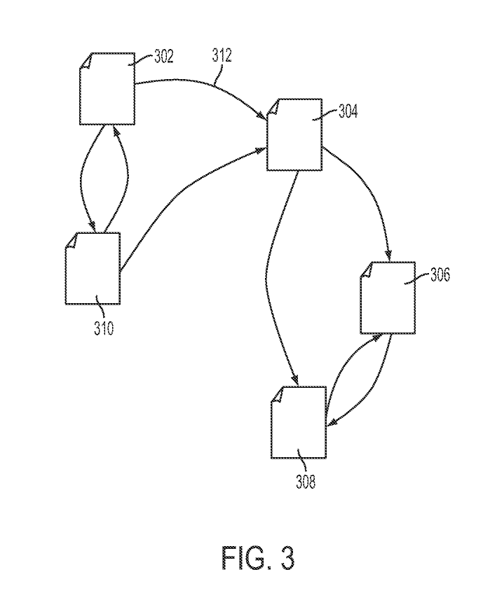

FIG. 3 shows an information unit graph 300 that can be generated based on the transition probability matrix 220 (FIG. 2). The information unit graph 300 can be generated to include digital documents matching query keywords, having a rank score above a specified rank score, and/or those digital documents having a transition probability that is greater than, or equal to, a probability transition threshold TPT value. To generate an information unit graph, the ranking unit identifies and selects one or more digital documents, such as one or more of the highly ranked digital documents from the set of digital documents 200 (FIG. 2), as an initial subset of digital documents to be represented as digital document nodes in one or more information unit graphs. The selected digital documents can be expanded upon to generate the information unit graphs.

Referring to FIG. 3, the ranking unit can select a digital document node 302 as starting point for generating an information unit from the set of digital documents 202 (FIG. 2). A transition probability for transitioning from the digital document node 302 to a digital document node 304 is compared to the transition probability threshold TPT value. If the transition probability for transitioning from a first digital document represented by a digital document node 302 to a digital document node 304 representing a second digital document is greater than or equal to the transition probability threshold TPT value, the digital document nodes 302 and 304 are connected in the information unit graph representing a connection between the first and second digital documents. In the present example, the transition probability for transitioning from the digital document node 302 to the digital document node 304 is greater than the transition probability threshold TPT value and the digital document node 302 is connected to the digital document node 304 via an edge 312.

The connection between the digital document node 302 and the digital document node 304 can be represented using an edge 312, which can be a line extending from the digital document node 302 to the digital document node 304 with an arrow pointing to the digital document node 304 to indicate that the connection is associated with a transition from the digital document node 302 to the digital document node 304. Digital documents that are connected by the ranking unit form an information unit and digital documents that are not connected by the ranking unit are excluded from the information unit.

The ranking unit can also determine whether to connect the digital document node 302 to any other digital document node by comparing the transition probabilities for transitioning from the digital document node 302 to each of the other digital documents to the transition probability threshold TPT value. For example, the transition probability for transitioning from digital document node 302 to digital document node 306 is compared to the transition probability threshold TPT value. If the transition probability for transitioning from the digital document node 302 to a digital document node 306 is greater than or equal to the transition probability threshold TPT value, the digital document nodes 302 and 306 are connected in the information unit graph representing a connection between the digital documents represented by the digital document nodes 302 and 306.

In the present example, the transition probability is less than the transition probability threshold TPT value. As a result, no connection is formed between the digital document node 302 and the digital document node 306. In some instances, the digital document node 302 can include a hyperlink to the digital document node 306. Despite the existence of a hyperlink between the digital document nodes 302 and 306, the digital document nodes 302 and 306 are not connected because the transition probability is less than the transition probability threshold TPT value.

The ranking unit can continue to generate the information unit by connecting digital documents having a transition probability that is greater than or equal to the transition probability threshold TPT. For example, the ranking unit can determine whether the digital document node 304, which has been connected to the digital document node 302, can be connect to any other digital documents, including being connected back to the digital document node 302, since the transition probability for transitioning from the digital document node 304 to the digital document node 302 can be different than the probability of transitioning from the digital document node 302 to the digital document node 304.

As an example, the ranking unit can compare the transition probability for transitioning from the digital document node 304 to the digital document node 306 to the transition probability threshold TPT value. In the present example, the transition probability for transitioning from the digital document node 304 to the digital document node 306 exceeds the transition probability threshold TPT value and a connection is formed between the digital document node 304 and the digital document node 306 to include the digital document node 306 in the information unit. An information unit formed starting with digital document node 302 includes the digital document nodes that are directly or indirectly connected to the digital document node 302. In the present example, digital document nodes 302, 304, 306, 308, and 310 for the information unit 300. Rank scores for information units generated by the ranking unit can be calculated based on the sum of the rank scores of the digital documents included the information units. Information units can be shared and combined by users.

A combined navigation behavior graph can be generated using one or more of the information unit graphs. The rank of the information units can be identified using rank identifiers, which can be implemented using different colors, highlighted text, a numbering scheme, or other rank identifiers. An information unit graph is identified as being highly ranked (e.g., having a high rank score relative to the other information units) if the information unit represented by the information unit graph contains digital documents whose summed rank score is high and there exists high transition probabilities between the digital documents of the information unit.

For example, a group of users can surf the Internet to find information about automobiles. The navigation behavior information of the users can be recorded and the tool 110 (FIG. 1) combines the navigation behavior information to form a collaborative navigation behavior information. In some embodiments, a client-side Internet Explorer toolbar or web server records the navigation behavior information of users. The recorded navigation behavior information can contain a user name, digital documents that the user visits, transitions between digital documents, an amount of time users spend on the digital documents, and the like.

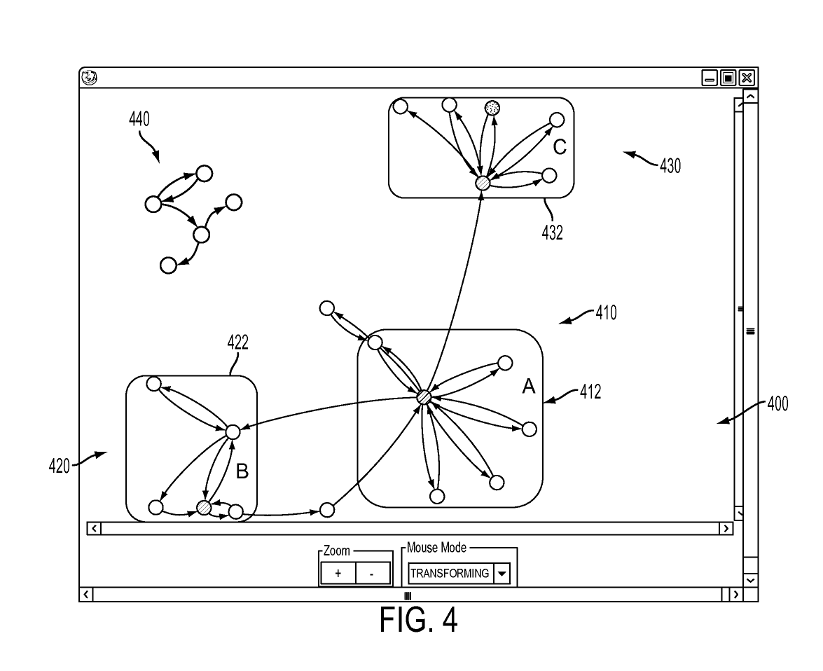

The information unit graphs can be used to generate a combined navigation behavior graph. FIG. 4 shows an exemplary combined navigation behavior graph 400 that can be generated by embodiments of the tool. In some embodiments, the combined navigation behavior graph can be generated in response to a keyword query. In these embodiments, information units can be retrieved from storage based on an index and a rank of the information units relative to the keywords used in the keyword query. The combined navigation behavior graph 400 can include information units 410, 420, and 430. The information units 410, 420, and 430 can be returned from a keyword query. The ranking of the information units 410, 420, and 430 can be identified using rank identifiers 412, 422, and 432. In the present example, the rank identifiers 412, 422, and 432 can be rectangles surrounding the information unit graphs 410, 420, and 430. As one example, the digital documents included in the information unit graph 410 can be directed to automobile development, manufacturing, and related historical figures; the digital documents included in the information unit graph 420 can be directed to automobile pollution; and the digital documents included in the information unit graph 430 can be directed to automobile traffic rules. The information unit graphs 410, 420, and 430 can aid, for example, in learning, reviewing, and/or organizing concepts associated with keywords included in a keyword query and/or the subject matter included in the information units.

In some embodiments, information units and/or combined navigation behavior graphs can be implemented in a 3D virtual world. Users can log into a 3D virtual world, such as second Life, from a web browser. 3D areas can be constructed to display digital documents associated with information units. 3D areas can be, for example, virtual rooms in which the digital documents are displayed as 3D objects, such as virtual posters on walls of a virtual room. For example, a virtual world can be used to automatically download information units, transfer digital documents associated with the information or references to the digital documents, such as URLs of web pages, contained in the information units to the 3D virtual world, and create 3D area for the information units. A tour guide or ‘virtual docent’ in the virtual world can guide users to browse digital documents in the 3D areas. Users can interact with each other and the digital documents using voice, text chat, highlighting, gestures, and the like in the 3D virtual world.

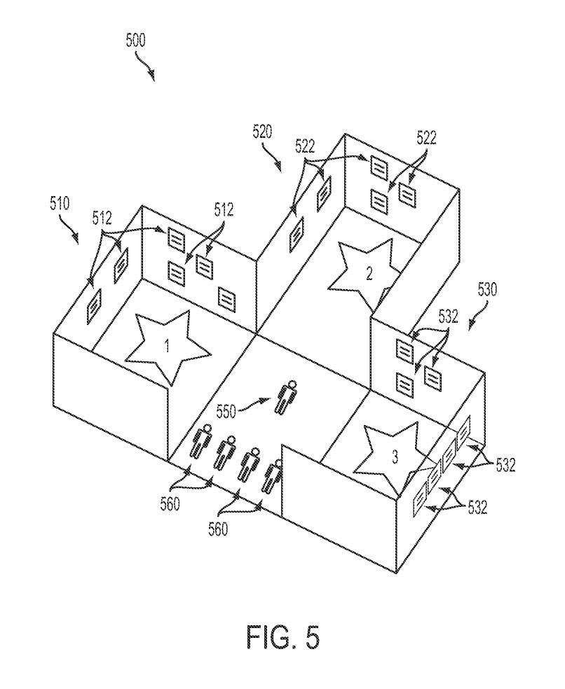

FIG. 5 are exemplary 3D areas 510, 520, and 530 generated to represent information units of a combined navigation behavior graph in a 3D world 500. The 3D areas 51, 520, and 530 can be virtual rooms in which digital documents can be displayed. For example, the 3D area 510 can include digital documents 512, the 3D area 520 can include digital documents 522, and the 3D area 530 can include digital documents 532. Rank identifiers 540, 542, and 544 can be disposed in the 3D areas 510, 520, and 530, respectively, to identify a rank of the information units represented in the 3D areas. A virtual docent 550 can be used to guide avatars 560, representing users of the virtual world, through the information units and/or the users can control the avatars to move through the 3D areas 510, 520, and 530 to view the digital documents 512, 522, and 532, respectively.

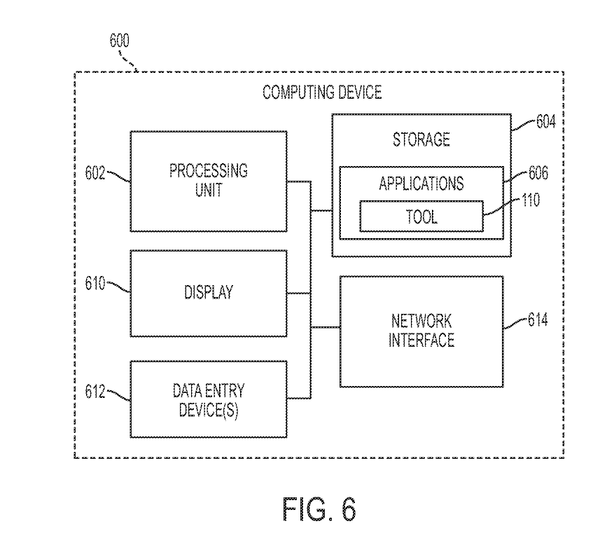

FIG. 6 is a block diagram of an exemplary computing device 600 configured to implement embodiments of the tool 110. The computing device 600 can be a mainframe, personal computer (PC), laptop computer, workstation, handheld device, such as a portable digital assistant (PDA), and the like. In the illustrated embodiment, the computing device 600 includes one or more processing unit 602, such as a central processing units (CPUs) and/or graphical processing units (GPUs), and can include storage 604. In some embodiments, the computing device 600 can further include or be communicatively coupled to a display device 610 and data entry device(s) 612, such as a keyboard, touch screen, and/or mouse.

The storage 604 stores data and instructions and can be implemented using one or more computer readable medium technologies, such as a floppy drive, hard drive, tape drive, Flash drive, optical drive, read only memory (ROM), random access memory (RAM), and the like. Applications 606, such as the tool 110, or portions thereof, can be resident in the storage 604. The instructions can include instructions for implementing embodiments of the tool 110. The one or more processing units 602 execute the applications 606, such as the tool 110, in storage 604 by executing instructions therein and storing data resulting from the executed instructions. The storage 604 can be local or remote to the computing device 600. The computing device 600 includes a network interface 614 for communicating with a network, such as the communication network 150 of FIG. 1.

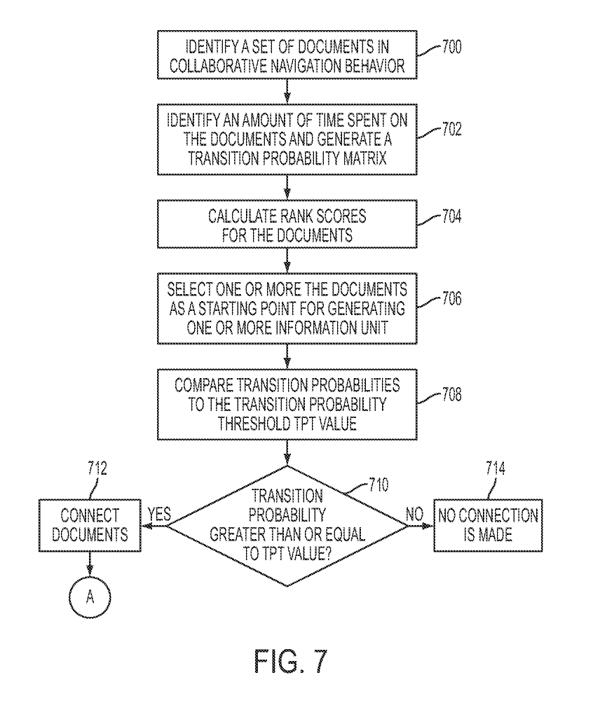

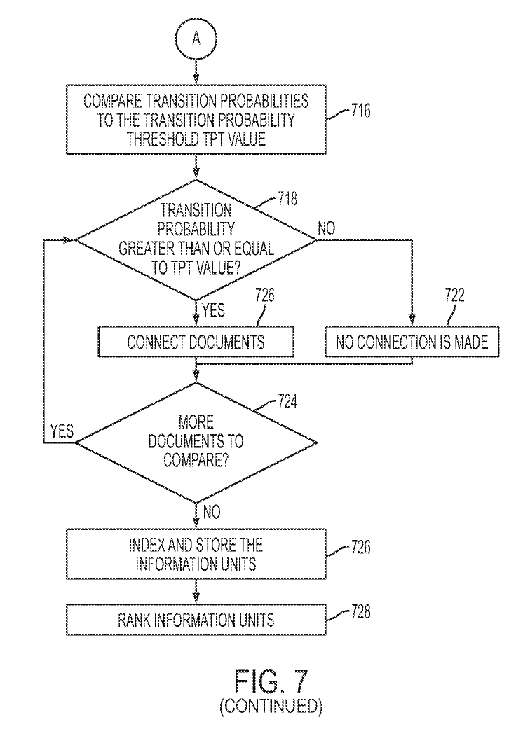

FIG. 7 is a flow chart illustrating a process for generating an information unit using collaborative navigation behavior information of a group of users. Digital documents in the collaborative navigation behavior information are identified by the tool 110 (FIG. 1) (700). The tool 110 identifies an amount of time spent on the digital documents, such as an amount of time each user spent on each document, and generates a transition probability matrix (702). Using the collaborative navigation behavior information, which can include the digital documents, amounts of time spent on the digital documents, and transitions used to calculate a transition probability matrix, the tool can calculate rank scores for the digital documents (704). The tool can use a continuous time-homogeneous Markov Process to calculate the rank scores of the digital documents. One or more of the digital documents can be selected as a starting point for generating one or more information unit (706). The selected one or more digital documents can be the highest ranked digital documents, arbitrary digital documents, and the like.

Transition probabilities for transitioning from the selected digital documents to other digital documents in the group are compared to the transition probability threshold TPT value (708). If the transition probability for transition from one of the selected digital documents to another digital document is greater than or equal to the transition probability threshold TPT (710), the selected digital document and the other digital document are connected (712). Otherwise, the selected digital document and the other digital document are not connected (714). The tool 110 can process the digital documents sequentially such that after the selected digital documents have been connected to other digital documents based on the transition probabilities, the transition probabilities for transitioning from the digital documents connected to the selected digital documents to other digital documents, including the selected digital documents, are compared to the transition probability threshold TPT value (716). If the transition probability for transitioning from one of the digital documents to another one of the digital documents is greater than or equal to the transition probability threshold TPT (718), the digital documents are connected (720). Otherwise, the digital documents are not connected (722).

The tool 110 can determine if any other digital documents are available for connection (724) and repeats from step 718 if there are more digital documents available for connection. This process can be continued until the transition probabilities for the digital documents have been compared to the transition probability threshold TPT value and the digital documents satisfying the transition probability threshold TPR value have been connected to each other. The connected digital documents can form one or more of information units. For example, the digital documents connected directly to, or through intervening digital documents, to one of the selected digital documents form an information unit. Information units can have digital documents in common and can have overlapping connections. When there are nor further digital documents for which transition probabilities can be compared to the transition probability threshold TPT, the information units are complete and can be ranked based on a rank score of the digital documents included in the information units (726). For example, the rank scores of the information units can be calculated based on a summation of the rank scores of the digital documents included in the information units. The information units can be indexed and stored for subsequent retrieval (728).

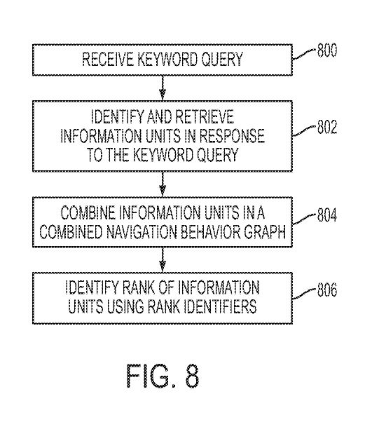

FIG. 8 is a flow chart illustrating a process of generating a combined navigation behavior graph in response to a keyword query. In the present example, a keyword query can be received by the tool 110 (FIG. 1) (800). Information units identified as being relevant to the keywords are retrieved from storage (802). In some embodiments, information having a rank score below a specified rank score may not be returned. The information units returned in response to the keyword query can be combined in a combined navigation behavior information graph (804) and the rank of the information units can be identified using rank identifiers (806). The combined navigation behavior information graph can provide a user with a learning path for learning about, reviewing, and/or organizing the subject matter of the digital documents included in the information units. For example, a user can navigate through the information units selecting digital documents having high rank scores and can follow a path from digital document to digital document based on the connections formed between the digital documents using the transition probabilities.

It will be appreciated that a variety of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A method for processing documents associated with one or more document environments to form an information unit comprising:
identifying digital documents associated with collaborative navigation behavior information for a group of users;
generating an information unit using transition probabilities calculated from collaborative navigation behavior information, the information unit including at least a subset of the digital documents identified in the collaborative navigation behavior information; and
calculating a rank of information units based on the collaborative navigation behavior information.

2. The method of claim 1, further comprising generating a combined navigation behavior information graph incorporating the information unit.

3. The method of claim 2, wherein generating a combined navigation behavior graph comprises:
receiving a keyword query;
retrieving information units in response to the keyword query;
combining the information units into the combined navigation behavior graph; and
identifying a rank of the information units.

4. The method of claim 1, wherein generating an information unit comprises:
identifying digital documents in collaborative navigation behavior information;
selecting a first one of the digital documents as a starting point for generating an information unit;
comparing a transition probability for transitioning from the first one of the digital documents to a second one of the digital documents to a transition probability threshold value; and
connecting the first one of the digital documents to the second one of the digital documents based on the comparing.

5. The method of claim 4, further comprising:
comparing a transition probability for transitioning from the second one of the digital documents to a third one of the digital documents to a transition probability threshold value; and
connecting the second one of the digital documents to the third one of the digital documents based on the comparing.

6. The method of claim 1, wherein calculating a rank of the information unit comprises:
identifying rank scores for digital documents included in the information unit;
adding the rank scores together to obtain a sum of the rank scores; and
assigning the sum of the rank scores to rank score of the information unit.

7. The method of claim 1, further comprising storing and indexing the information unit for subsequent retrieval.

8. The method of claim 1, further comprising:
generating a 3D area in a virtual world for the information unit;
transferring the digital documents included in the information unit into the 3D area; and
displaying the digital documents in the 3D area.

9. A computer readable medium storing instructions executable by a computing system including at least one computing device, wherein execution of the instructions implements a method for processing documents associated with one or more document environments to form an information unit comprising:
identifying digital documents associated with collaborative navigation behavior information for a group of users;
generating an information unit using transition probabilities calculated from collaborative navigation information, the information unit including at least a subset of the digital documents identified in the collaborative navigation behavior information; and
calculating a rank of information units based on the collaborative navigation behavior information.

10. The medium of claim 1, wherein execution of the instructions implement a method further comprising generating a combined navigation behavior information graph incorporating the information unit.

11. The medium of claim 10, wherein generating a combined navigation behavior graph comprises:
receiving a keyword query;
retrieving information units in response to the keyword query;
combining the information units into the combined navigation behavior graph; and
identifying a rank of the information units.

12. The medium of claim 9, wherein generating an information unit comprises:
identifying digital documents in collaborative navigation behavior information;
selecting a first one of the digital documents as a starting point for generating an information unit;
comparing a transition probability for transitioning from the first one of the digital documents to a second one of the digital documents to a transition probability threshold value; and
connecting the first one of the digital documents to the second one of the digital documents based on the comparing.

13. The medium of claim 12, wherein execution of the instructions implement a method further comprising:
comparing a transition probability for transitioning from the second one of the digital documents to a third one of the digital documents to a transition probability threshold value; and
connecting the second one of the digital documents to the third one of the digital documents based on the comparing.

14. The medium of claim 9, wherein calculating a rank of the information unit comprises:
identifying rank scores for digital documents included in the information unit;
adding the rank scores together to obtain a sum of the rank scores; and
assigning the sum of the rank scores to rank score of the information unit.

15. The medium of claim 9, further comprising storing and indexing the information unit for subsequent retrieval.

16. The medium of claim 9, wherein execution of the instructions implement a method further comprising:
generating a 3D area for the information unit;
transferring the digital documents included in the information unit into the 3D area; and
displaying the digital documents in the 3D area.

17. A system for processing documents associated with one or more document environments to form an information unit comprising:
a computing system including at least one computing device, the computing system configured to:
identify digital documents associated with collaborative navigation behavior information for a group of users;
generate an information unit using transition probabilities calculated from collaborative navigation information, the information unit including at least a subset of the digital documents identified in the collaborative navigation behavior information; and
calculate a rank of information units based on the collaborative navigation behavior information.

18. The system of claim 17, wherein the computing system is configured to generate a combined navigation behavior information graph incorporating the information unit in response to receiving a keyword query by retrieving information units in response to the keyword query, combining the information units into the combined navigation behavior graph, and identifying a rank of the information units.

19. The system of claim 17, wherein the computing system is configured to generate an information unit by identifying digital documents in collaborative navigation behavior information, selecting a first one of the digital documents as a starting point for generating an information unit, comparing a transition probability for transitioning from the first one of the digital documents to a second one of the digital documents to a transition probability threshold value, and connecting the first one of the digital documents to the second one of the digital documents based on the comparing.

20. The method of claim 17, wherein the computing system is configured to calculate a rank of the information unit by identifying rank scores for digital documents included in the information unit, adding the rank scores together to obtain a sum of the rank scores, and assigning the sum of the rank scores to rank score of the information unit.
